(19) United States
(12) Patent Application Publication
(10) Pub. No.: US 2012/0323680 A1
(43) Pub. Date: Dec. 20, 2012

(54) DISPLAY OF ADVERTISEMENTS

(76) Inventor: Xin Zhou, Haidian (CN)

(21) Appl. No.: 13/517,481

(22) PCT Filed: Dec. 22, 2009
(86) PCT No.: PCT/CN09/75848

§ 371 Date: Aug. 30, 2012

(51) Int. Cl. G06Q 30/02

(52) U.S. Cl. 705/14.49; 705/14.73; 705/14.69

(57) ABSTRACT

A computer-implemented method for displaying advertisements is provided. At a server computer, a request from a client device is received; and at the server computer, a web page is delivered in response to the request to the client device. The web page has a predetermined width when shown in a browser window having a width greater than the predetermined width. The web page includes instructions to enable the web browser to display an ad module in a blank area between a border of the web page and a border of the browser window when the width of the browser window associated with a web browser window is larger than the predetermined width.

### TECHNICAL FIELD

This document generally relates to information management.

### BACKGROUND

Web pages provide a wide variety of information for a broad audience. Content items on web pages can potentially be accessed by users anywhere in the world who have connections to the Internet. Web sites may include advertisements for products or services in addition to content items provided by the publishers of the web sites. Advertisements may also be referred to as sponsored content. In some examples, the publishers may determine what advertisements to place on their web pages, and display the content items and advertisements on the web pages according to particular layout designs. In other examples, publishers provide advertisement spaces for display of advertisements provided by ad networks. The ad networks may place text or image advertisements on web pages that have content related to the advertisements. As the users are likely interested in the particular content on the publisher web page, they are also likely to be interested in the product or service featured in the advertisement. Such targeted advertisement placement can provide ad revenue to the publisher and help drive online customers to the advertiser's web site.

### SUMMARY

In general, in one aspect, a computer-implemented method for displaying advertisements is provided. At a server computer, a request from a client device is received; and at the server computer, a web page is delivered in response to the request to the client device. The web page has a predetermined width when shown in a browser window having a width greater than the predetermined width. The web page includes instructions to enable the web browser to display an ad module in a blank area between a border of the web page and a border of the browser window when the width of the browser window is larger than the predetermined width.

Implementations may include one or more of the following features. Delivering the web page can include delivering instructions for the web page to enable the web browser to determine a width of the blank area and display the ad module at a position determined according to the width of the blank area. Delivering the web page can include delivering instructions for detecting resizing of the browser window and removing the ad module previously displayed in the blank area when the blank area has a width that is smaller than the width of the ad module. Delivering the web page can include delivering instructions for the web page to enable the web browser to display a first ad module in a first blank area between a left border of the web page and a left border of the browser window, and a second ad module in a second blank area between a right border of the web page and a right border of the browser window. Delivering the web page can include delivering instructions including a function call for identifying ad modules that can be shown in a blank area. Delivering the web page can include delivering instructions including a function call for searching ad modules that are associated with a particular class name. A advertisers can be charged a first price for advertisements that are shown in the blank area and charged a second price for advertisements that are shown within the web page, the second price being different from the first price. Delivering the web page can include delivering instructions to enable the web browser to keep the ad module visible in the blank area independent of scrolling of the content area in the browser window. Delivering the web page can include delivering instructions for an ad module that displays at least one of advertisements that match the content of the web page or advertisements that match search results associated with the web page.

In general, in another aspect, a computer-implemented method for displaying advertisements includes: at a server computer, receiving a request from a client device; and at the server computer, delivering content and instructions for formatting a layout of the content in response to the request to the client device. The content is formatted to be shown in a content area that has a predetermined width when shown in a window having a width greater than the predetermined width, and the instructions enable the client computer to display an advertisement in a blank area between a border of the content area and a border of the window when the width of the window is larger than the predetermined width.

Implementations may include one or more of the following features. Receiving the request can include receiving a request to use an application program, and delivering the content and instructions can include delivering an interface for using the application program and instructions for formatting the interface, in which the interface is formatted to have the predetermined width when shown in a window having a width greater than the predetermined width. Delivering the interface can include delivering an interface for using a web-based application that is hosted on the server computer. Delivering the content can include delivering content that includes items that are provided by a publisher of the content and advertisements that are sponsored by an entity different from the publisher, in which the advertisements shown in the blank area are in addition to the advertisements shown in the content area. Delivering the instructions can include delivering instructions that enable the client computer to remove the advertisements in the blank area and maintain the advertisements in the content area when the window is resized to have a width that is less than the predetermined width. Delivering the content and instructions can include delivering an advertisement module that retrieves advertisements from an ad network and allows the advertisements to be shown in the blank area. The ad network can, for example, broker the purchase and sale of advertisements.

In general, in another aspect, a computer-implemented method for displaying advertisements is provided. At a server computer, a request from a client device is received; and at the server computer, a web page in response to the request to the client device is delivered. The web page is shown in a browser window associated with a web browser, and the web page has a content area to display content, the content area being formatted to have a predetermined width. At the server computer, information about a width of the browser window is received, and the web page is updated to display an advertisement in a blank area between a border of the content area and a border of the browser window if a width of the browser window is larger than the predetermined width.

Implementations may include one or more of the following features. A width of the blank area can be calculated, and the advertisement can be formatted for display in the blank area. Delivering the web page can include delivering content provided by a publisher of the web page and advertisements that are sponsored by an entity different from the publisher, in which the advertisements shown in the blank area are in addition to the advertisements shown in the content area. The web page can be updated to remove the advertisements in the blank area and the advertisements can be maintained in the content area when the browser window is resized to have a width that is less than the predetermined width.

In general, in another aspect, a computer-implemented method includes providing an application programming interface (API) that includes a function call for searching advertisement modules for showing advertisements in a blank space between a border of a web page and a border of a browser window, receiving an instruction to invoke the function call, and enabling execution of the function call to identify advertisement modules for showing advertisements in the blank space.

Implementations may include one or more of the following features. Providing the API can include providing a function call that calls a JavaScript™ program for searching the advertisement modules.

In general, in another aspect, a computer implemented method includes providing a user interface to allow an advertiser to manage on-line ads; and providing an option for the advertiser to determine whether an on-line advertisement can be shown in a blank area outside of a web page, the content area having a predetermined width when a width of a browser window showing the web page is larger than the predetermined width.

Implementations may include one or more of the following features. Pricing information can be provided to the advertiser to show a difference in pricing for showing the ad within the web page and showing the ad in the blank area. An option can be provided for the advertiser to determine whether the advertisement shown in the blank area is to scroll along with the content area or remain visible on the browser window independent of scrolling of the web page in the browser window.

In general, in another aspect, an apparatus includes a storage device and a server computer. The storage device stores a web page that includes content and a set of instructions. The set of instructions includes instructions for formatting the content to be displayed within the web page, the web page having a predetermined width when shown in a browser window having a width greater than the predetermined width. The set of instructions includes instructions for enabling a web browser to place an ad module in a blank area between a border of the web page and a border of the browser window when the width of the browser window is larger than the predetermined width. The server computer delivers the web page to a client device in response to a request from the client device.

Implementations may include one or more of the following features. The set of instructions can include program code for searching ad modules that are configured to be shown only in the blank area or to be shown in either the blank area or the web page.

In general, in another aspect, an apparatus includes a storage device to store a web page formatted to have a predetermined width when shown in a browser window having a width greater than the predetermined width. The web page includes code to enable a web browser to display an ad module in a blank area between a border of the web page and a border of the browser window when the width of the browser window is larger than the predetermined width. The apparatus includes means for delivering the web page to a client device to cause the web page to be shown in a browser window at the client device.

These and other aspects and features, and combinations of them, may be expressed as methods, apparatus, systems, means for performing functions, program products, and in other ways.

Advantages of the aspects and features include none, one, or more of the following. Advertisements can be displayed alongside a web page when a browser window or a display screen for displaying the web page is wider than the web page. Advertisements may attract more attention and have higher click-through-rates or conversion rates. More ad revenue may be generated for advertisers and publishers of web pages.

The details of one or more implementations are set forth in the accompanying drawings and the description below. Other features and advantages will be apparent from the description and drawings, and from the claims.

### DESCRIPTION OF DRAWINGS

FIG. 1 is a block diagram of an example online environment.

FIGS. 2A, 2B, and 3 each shows a diagram of a web page being shown in a browser window.

FIGS. 4 to 8 are flow diagrams.

FIG. 9 is a schematic representation of a general computing system.

Like reference symbols in the various drawings indicate like elements.

### DETAILED DESCRIPTION

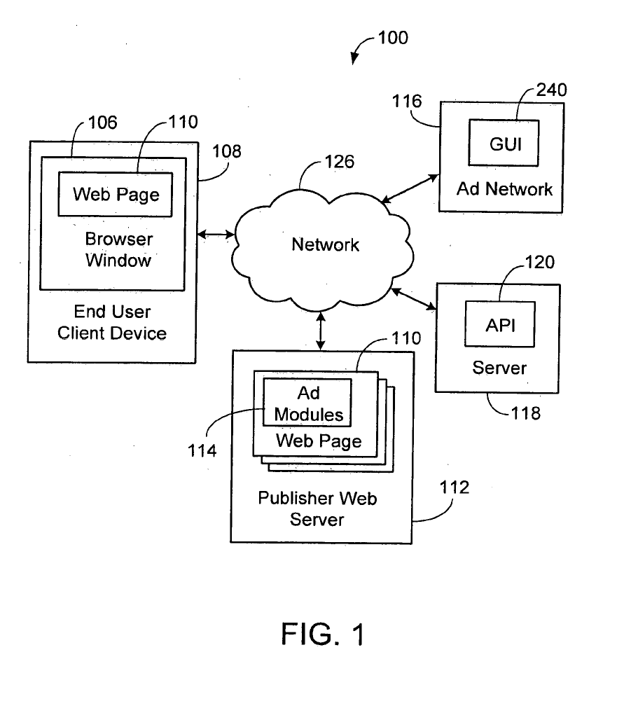

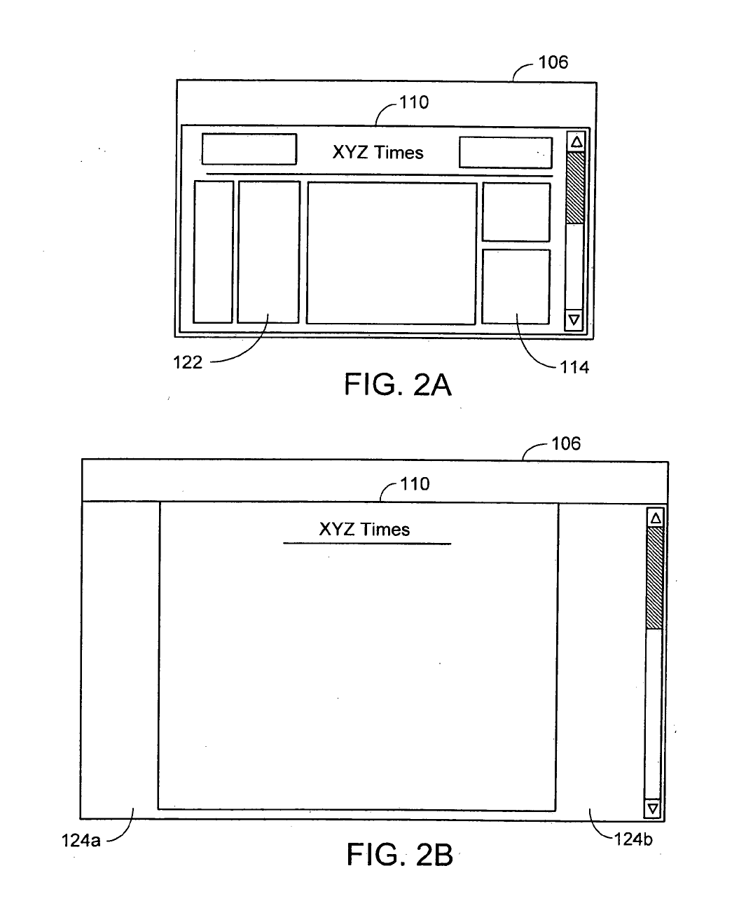

FIG. 1 is a block diagram of an example online environment 100 that facilitates the serving of web pages from publishers to end users through a network 126. An end user may use a web browser executing on a client device 108 to access web pages 110 hosted on a web server 112 of a publisher. The web page is shown on a browser window 106. The web pages 110 may include ad modules 114 for retrieving ads from ad networks 116 and displaying the ads on the web pages 110. In some examples, each web page 110 is formatted to have a predetermined width (e.g., 1024 pixels). When the browser window 106 has a width that is greater than the width of the web page 110, there will be blank areas (e.g., 124a and 124b in FIG. 2B) between the borders of the web page 110 and the borders of the browser window 106. The web page 110 may be configured to show ad modules 114 in the previously blank areas to increase visibility of the ads, potentially increasing revenue to the advertisers 105 and the publisher 102 of the web page 110.

As described in more detail below, some ad modules can be shown in the blank area rather than in the web page itself (i.e., they are moved from the web page to the blank areas), some ad modules can be shown in both the web page and the blank areas, and some ad modules are only shown in the blank areas (i.e., they are not shown to the user when there is no blank area).

A server 118 may provide an application programming interface (API) 120 including various function calls that aid the publisher in implementing display of ad modules 114 in the blank areas. For example, the web pages 110 may include code that uses the API 120 for identifying which ad modules 114 can be displayed in the blank area.

In FIG. 1, although only one client device 108, one web server 112, and one ad network 116 are shown, the online environment 100 may include many more client devices, web servers, and ad networks. The term “end user” refers to a consumer of content and ads provided by the publishers and advertisers. The advertiser can refer to an entity (e.g., an individual or company) whose products or services are being advertised, or an entity that sponsors an advertisement. The network 126 can be, e.g., a local area network (LAN), a wide area network (WAN), the Internet, or a combination thereof.

The ad network 116 brokers the purchase and sale of advertisements. The ad network 116 (or a server computer of the ad network) may provide a user interface 130 (e.g., a graphical user interface, or GUI) to allow the advertiser to directly or indirectly enter, maintain, and track advertisement information related to the advertisements provided by the advertiser.

The GUI 130 may provide an option for the advertiser to determine whether an on-line advertisement can be shown in a blank area outside of a web page. The GUI 130 may provide pricing information to the advertiser to show a difference in pricing for showing the ad within the web page and showing the ad in the blank area.

The GUI 130 may provide an option for the advertiser to determine whether the advertisement shown in the blank area is to scroll along with the web page or remain visible in the browser window independent of scrolling of the web page. For example, the price for ads that remain visible in the browser window independent of scrolling of the web page may be more expensive than the price for ads that scroll along with the web page.

The advertisements can be in the form of graphical advertisements, such as banner advertisements, text only advertisements, image advertisements, audio advertisements, video advertisements, or advertisements combining one of more of such components, or any other type of electronic advertisement document. The advertisements may also include embedded information, such as links, meta-information, and/or machine executable instructions, such as HTML or JavaScript™.

The web page 110 can include advertisements provided by the ad network 116, or include executable instructions, e.g., JavaScript™ instructions, that can be executed at the client device 108 to request advertisements from the ad network 116. Examples of the end user devices 108 include personal computers, mobile communication devices, and television set-top boxes.

The advertisements can be provided from the publishers. For example, the publisher may maintain an inventory of advertisements. The publisher can also submit requests for advertisements to the ad network 116. The ad network 116 responds by sending the advertisements to the requesting publisher for placement on one or more of the publisher's web pages. The advertisements can include embedded links to landing pages, e.g., pages on the advertiser's web sites, that an end user is directed to when the end user clicks an ad presented on a publisher's web page. The publisher can embed the advertisements in the web page 110 and send the web page 110 along with the advertisements to the client device 108.

In this document, the term publisher and advertiser, depending on context, can either refer to the human publisher and advertiser, or computers operated by the publisher and advertiser, respectively.

The advertiser, client device 108, and/or the web server 112 can provide usage information to the ad network 116. The usage information can include measured or observed end user behavior related to advertisements that have been served, such as whether or not a conversion or a selection related to an advertisement has occurred. The ad network 116 performs financial transactions, such as crediting the publisher and charging the advertiser, based on the usage information. Such usage information can also be processed to measure performance metrics, such as a click-through rate (CTR), and conversion rate. The performance metrics can be used to determine the fees that the advertiser pays to the ad network 116, a portion of which may be paid to the publisher.

Referring to FIG. 2A, a web page 110 of a newspaper site may be formatted to have a width of 1024 pixels. The web page 110 includes content items 122, which may include, for example, articles, photos, videos, and ad modules 114. The articles may contain information related to current national and international events, health, science, technology, sports, finance, and religion, for example. The ad modules 114 may display ads retrieved from the ad network 116, which may select ads using various criteria, such as matching content of the ad to the content of the articles.

When the web page 110 is viewed in a browser window 106 having a width of 1024 pixels or more, the web page 110 fits within the browser window 106. If the browser window 106 has a width that is less than 1024 pixels, the browser window 106 may show only a portion of the web page 110.

Referring to FIG. 2B, when the web page 110 is viewed in a browser window 106 having a width greater than 1024 pixels (e.g., 1600 pixels), there will be a blank area 124a to the left of the web page 110 and a blank area 124b to the right of the web page 110. Here, it is assumed that the web page 110 is formatted to be center-aligned when being shown in a browser window 106 that is wider than the web page. For example, the web page 110 may use a style “width:auto;padding:0;” in the “body” portion of the source code or in the body's main division in order to position the web page 110 near the center of the browser window 106. The source code can be, e.g., hypertext markup language (HTML) code. If some cases, the blank areas 124a and 124b may be sufficiently wide to display additional ad modules 114.

In the examples of FIGS. 2A and 2B, the web page 110 is shown in the browser window 106. It is possible to show the web page 110 in full screen mode, in which a browser window is not used and the web page 110 fills the entire screen of a display. For example, the web page 110 may fill the entire screen having 1024x768 resolution. When the web page 110 is shown in full screen mode on a display having, e.g., 1600x1200 resolution, there will be blank areas between the web page and the borders of the viewing area of the display.

The description below explains how ad modules 114 can be shown in the blank areas when the web page 110 is shown in a browser window 106 that is wider than the web page 110. The same principle can be used to show ad modules 114 in the blank areas when the web page 110 is shown in full screen mode on a screen that is wider than the web page 110. In this description, a display screen is assumed to have an array of rows and columns of pixels, and the width of a screen, a window, or a web page is measured in terms of pixels. When reference is made to a screen or window that is wider than a web page, this means that the number of pixels in a row of the screen or window is greater than the number of horizontal pixels used to show the web page.

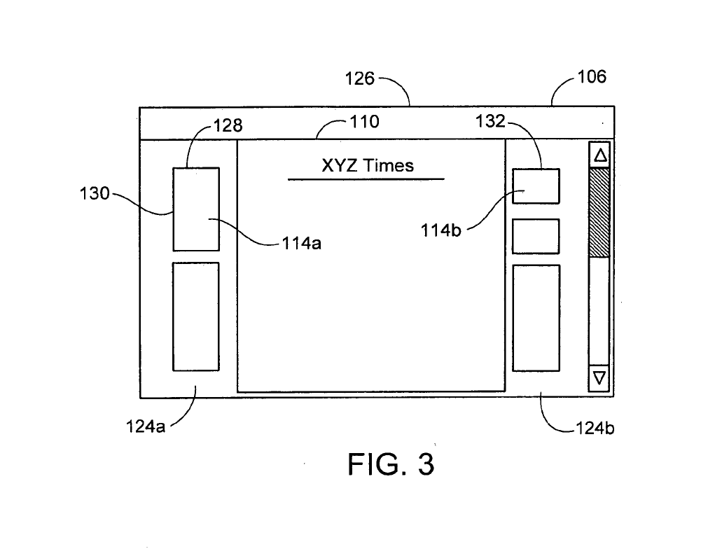

Referring to FIG. 3, if an ad module 114 has a minimum width of n pixels, and the width of a blank area 124a or 124b is greater than n pixels, then the ad module 114 may be shown in the blank areas 124. For example, if the web page 110 is positioned at the center of the browser window 106, ad modules 114a and 114b can be shown in the blank areas 124a and 124b on both sides of the web page 110 when the difference in width between the browser window 106 and the web page 110 is greater than 2*n pixels, with the browser window 106 being wider than the web page 110.

The web page 110 may include source code (e.g., HTML code) for the ad modules 114. Some of the ad modules 114 may be configured to be shown only within the web page 110, some of the ad modules 114 may be configured to be shown only in the blank areas 124, and some of the ad modules may be configured to be shown in the web page 110 and the blank areas 124 if blank areas are available.

In some examples, <div class=“blank_area_ads”> and </div> tags can be placed around an ad module 114 that is configured to be shown in the blank areas 124. This makes it easier to identify which ad modules 114 can be shown in the blank areas 124. For example, a JavaScript™ program can be used to auto-detect the current size (e.g., width and height) of the browser window 106. If the window width is larger than the web page width, another JavaScript™ program can be used to search the “div” elements and identify the ones that have the attributes of “blank_area_ads.” The “position” attribute of such “div” elements can be set to be “absolute,” and the “div” elements can be aligned in the blank area 124 by changing the “top” and “left” attributes of the “div” elements.

For example, to place ads in the blank areas of the XYZ Times web site, <div class=“blank_area_ads”> and </div> may be added near the end of the HTML code of the www.xyztimes.com web site. Ad modules that are intended for placement in the blank areas are placed in this “div” element, and “<script src=‘http://www.google.com/blank_ads_api.js’></script>” is added into the HTML of the www.xyztimes.com web site. The URL “http://www.google.com/blank_ads_api.js” provides a link to the source code of the API that can be used for identifying which ad modules can be displayed in the blank area. The ad module can display, for example, iFrame ads, image ads, text ads, or HTML ads. The API can also be used for displaying ad modules in the blank areas when the width of the browser window is larger than the predetermined width.

Examples of properties for the display of ads in the blank areas that can be set in JavaScript™ include:

<script>

// set the ads arrangement as “Row first/column first”
BLK_ADS_type = BLK_ADS_ROW_FIRST;
// set the ads layout as 1 column or 2 columns
BLK_ADS_column = 2;
// set the ads module shown by default or not
BLK_ADS_shown_default = false;
// set other properties
.....................
.....................

</script>

A function call, such as on SizeCallback( ), whose pseudo code is shown below, can be implemented for placing ad modules in the blank areas. This function call first determines whether the size of the screen (or browser window) is wider than the web page. For each ad module having a class name equal to “blank_area_ads,” a PutAdsModuleOnBlankColumn( ) function call is invoked to place the ad module in the blank area. The PutAdsModuleOnBlankColumn( ) function call may call a JavaScript™ program.

=========================================
function onSizeCallback( ) {

if(screen's size is wider than the page width) {

Foreach(the class name is equal to “blank_area_ads”) {

PutAdsModuleOnBlankColumn( )

}

}

}
=========================================

The PutAdsModuleOnBlankColumn( ) function call may determine the absolute positions for the ad modules according to the widths of the ad modules, the width of the web page 106, and the width of the blank areas 124. For example, suppose the web page is 1024 pixels wide and the browser window 106 has a width of 1500 pixels. Each blank area 124 has a width of 238 pixels. An ad module 114 having a width equal to 238 pixels or less can be placed in the blank area 124. For example, suppose that an ad module 114a with a width of 100 pixels is to be placed with a 40-pixel margin from the top border 126 of the window 106 and a 10-pixel spacing between the ad module 114a and the web page 110. The attributes of the “div” element containing the ad module 114 can be configured such that the top border 128 of the ad module 114a is at the 40+1=41^{st} row of the window 106, and the left border of the ad module 114a is at the 238−10−100+1=139^{th} column of the window 106.

Similarly, to place an ad module 114b with a 40-pixel margin from the top border 126 of the window 106 and a 10-pixel spacing between the ad module 114b and the web page 110, the attributes of the “div” element containing the ad module 114 can be configured such that the top border 132 of the ad module 114b is at the 40+1=41st row of the window 106, and the left border of the ad module 114b is at the 238+1024+10+1=1273^{rd} column of the window 106. When the browser window 106 is resized, the absolute positions of the ad modules 114a and 114b can be recalculated in a similar manner.

In some implementations, the publisher 102 or ad network 116 may charge the advertiser 105 a first price for advertisements that are shown in the blank area and charge the advertiser 105 a second price for advertisements that are shown within the web page, in which the second price is different from the first price.

The ad module 114 can be, for example, a content ad module that displays advertisements that match the content of the web page 110, or a search ad module that displays advertisements that match search results associated with the web page 110. The ad modules 114 can be configured such that the web browser keeps the ad modules 114 visible in the blank area independent of scrolling of the web page 110 in the browser window 106. The ad modules 114 can also be configured to scroll along with the web page 110 in the browser window 106.

In some implementations, a server computer may provide a web-based application that is hosted on the server computer. The server computer may deliver a graphical user interface to the device 108 to allow the end user 104 to access the functionalities provided by the web-based application. The server computer may deliver instructions for formatting the interface. The graphical user interface may have a predetermined width when shown in a window at the client device 108. The web-based application may be supported by advertisements that are shown in blank areas between the interface and the borders of the window. Display of ad modules in the blank areas may be implemented in a manner similar to the examples described above.

The web-based application can be, e.g., a word processing application, a spreadsheet application, an electronic mail application, a calendar application, a web browsing application, a messaging application, a video conferencing application, a search application, a video management application, a photo management application, a music file management application, a file sharing application, a mapping application, a data management application, a data analysis application, a math processing application, a computer assisted design application, a web design application, a medical record management application, an application for purchasing or trading goods or services, an application for managing energy use, an application for remote monitoring, or an application for accessing a database.

In the examples described above, the web server 112 delivers a web page having a predetermined width, and the web browser when rendering the source code of the web page executes function calls for displaying ad modules in blank areas between the web page and the borders of the browser window. In some implementations, the web server 112 may update the web page to take into account of the browser window size and embed ad modules in blank areas in the web pages.

For example, a web page may be formatted to show content (e.g., articles, images, video, and ad modules) within a content area. The content area may have a predetermined width of, e.g., 1024 pixels. The web server 112, upon receiving a request from the client device 108, may deliver a web page 110 in response to the request to the client device 108. The web page 110 is shown in a browser window 106 at the client device 108. The web page 110 may include code for determining the width of the browser window and sending the width information to the web server 112. The web server 112 may use the width information to update the web page to display an ad module in a blank area between a border of the content area and a border of the browser window if a width of the browser window is larger than the predetermined width of the content area.

In this example, the web server determines the width of the blank area, and formats the advertisement for display in the blank area. The web page includes code for detecting resizing of the browser window, upon which the new window size is sent to the web server 112, which uses the window size information to update the web page 110 to add more ad modules to be blank areas, or remove the ad modules from the blank areas if the blank area is too small to display the ad modules. When the ad modules in the blank areas are removed, the web server 112 does not remove the ad modules in the content area.

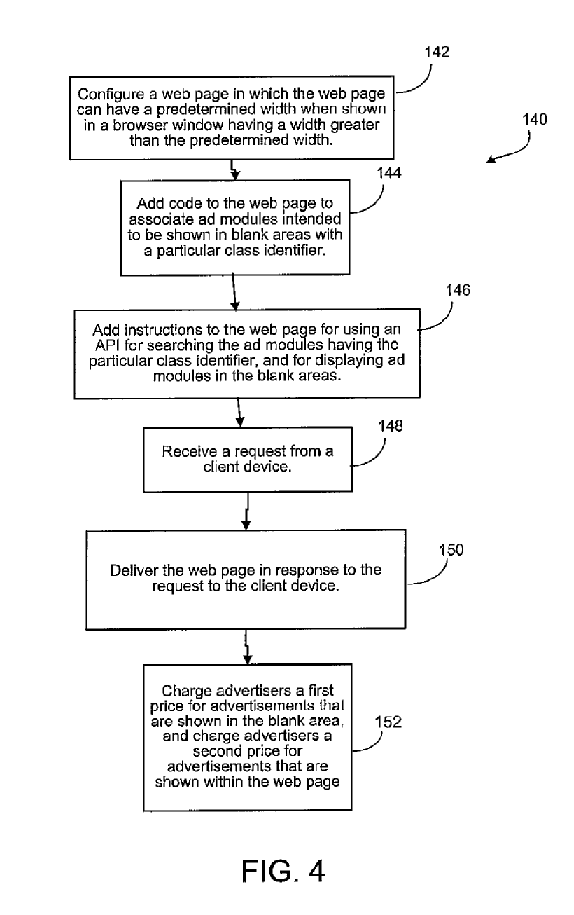

FIG. 4 is a flow diagram of an example process 140 for displaying advertisements. The process 140 can be implemented by, for example, the web server 112 of FIG. 1. The process 140 includes configuring 142 a web page, in which the web page can have a predetermined width when shown in a browser window having a width greater than the predetermined width. Ad modules intended to be shown in blank areas are associated 144 with a particular class identifier. For example, <div class=“blank_area_ads”> and </div> tags can be placed around an ad module that is configured to be shown in the blank areas, and the tags and the ad module can be placed near the end of the HTML code for the web page.

Instructions for using an API for searching the ad modules having the particular class identifier, and for displaying ad modules in the blank areas, are added 146 to the web page. For example, “<script src=‘http://www.google.com/blank_ads_api.js’</script>” can be added to the HTML code of the web page.

The process 140 includes receiving 148 a request from a client device and delivering 150 the web page in response to the request to the client device. The client device can be, for example, the client device 108.

In some implementations, the process 140 includes charging 152 advertisers a first price for advertisements that are shown in the blank area, and charging advertisers a second price (different from the first price) for advertisements that are shown within the web page.

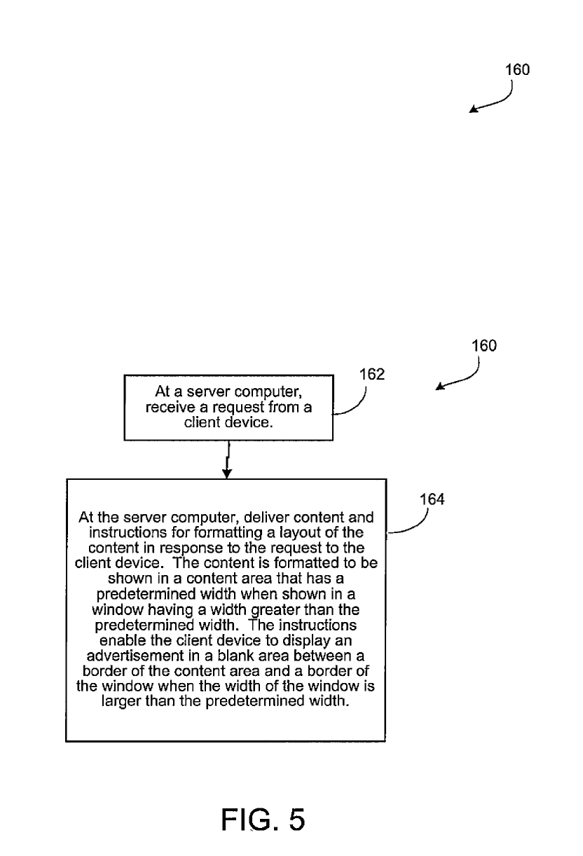

FIG. 5 is a flow diagram of an example process 160 for displaying advertisements. The process 160 includes, at a server computer, receiving 162 a request from a client device. For example, the server computer can be the web server 112 of FIG. 1, and the client device can be the client device 108.

The process 160 includes, at the server computer, delivering content and instructions for formatting a layout of the content in response to the request to the client device. The content is formatted to be shown in a content area that has a predetermined width when shown in a window having a width greater than the predetermined width. The instructions enable the client device to display an advertisement in a blank area between a border of the content area and a border of the window when the width of the window is larger than the predetermined width.

In some implementations, the request can be a request to use an application program, and the content and instructions can be an interface for using the application program and instructions for formatting the interface. The interface can be formatted to have the predetermined width when shown in a window having a width greater than the predetermined width. The interface can be an interface for using a web-based application that is hosted on the server computer.

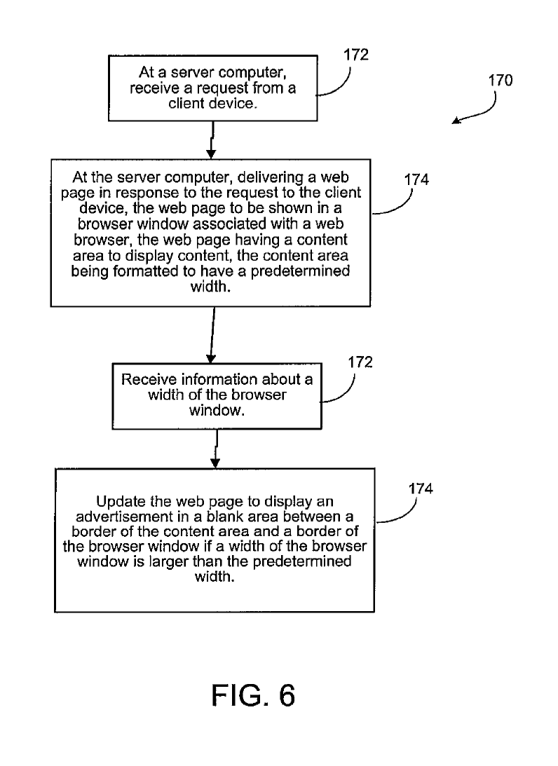

FIG. 6 is a flow diagram of an example process 170 for displaying advertisements. The process 170 includes, at a server computer, receiving 172 a request from a client device. For example, the server computer can be the web server 112 of FIG. 1, and the client device can be the client device 108.

The process 170 includes, at the server computer, delivering 174 a web page in response to the request to the client device, the web page to be shown in a browser window associated with a web browser, the web page having a content area to display content, the content area being formatted to have a predetermined width.

The process 170 includes receiving 176 information about a width of the browser window, and updating 178 the web page to display an advertisement in a blank area between a border of the content area and a border of the browser window if a width of the browser window is larger than the predetermined width.

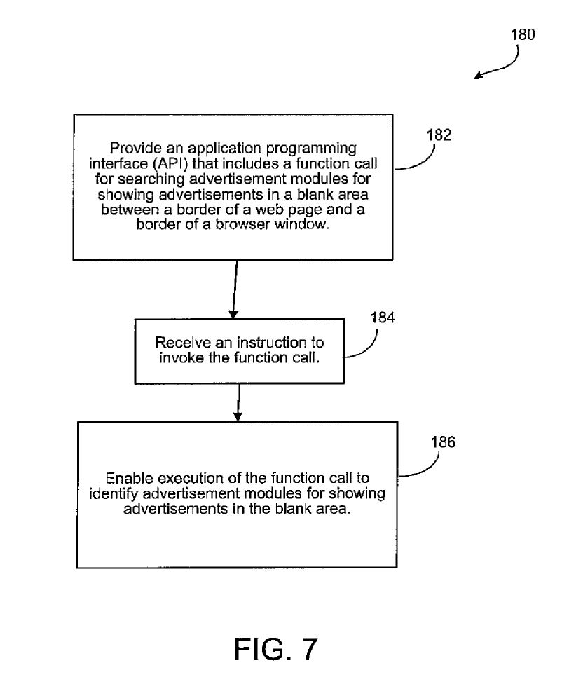

FIG. 7 is a flow diagram of an example process 180 for enabling display of advertisements in blank areas. The process 180 includes providing 182 an application programming interface (API) that includes a function call for searching advertisement modules for showing advertisements in a blank area between a border of a web page and a border of a browser window.

The process 180 includes receiving 184 an instruction to invoke the function call, and enabling 186 execution of the function call to identify advertisement modules for showing advertisements in the blank area.

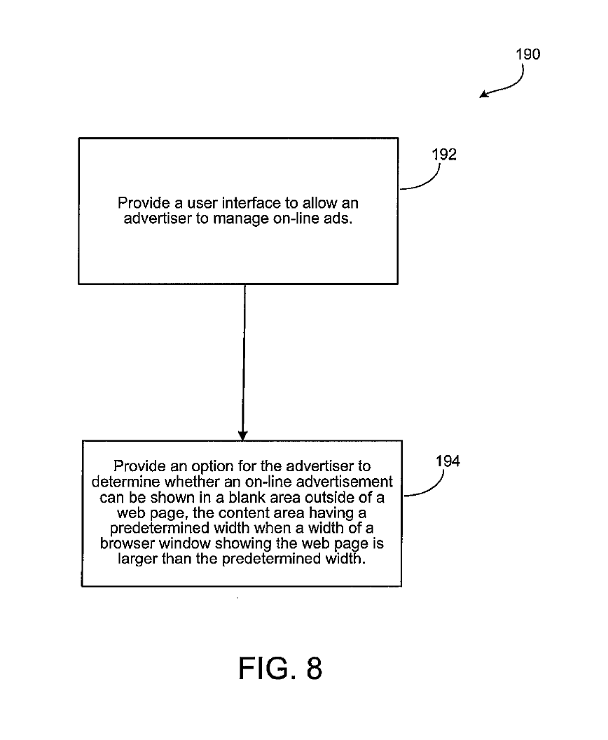

FIG. 8 is a flow diagram of an example process 190 for managing on-line ads. The process 190 includes providing 192 a user interface to allow an advertiser to manage on-line ads, and providing 194 an option for the advertiser to determine whether an on-line advertisement can be shown in a blank area outside of a web page, the content area having a predetermined width when a width of a browser window showing the web page is larger than the predetermined width.

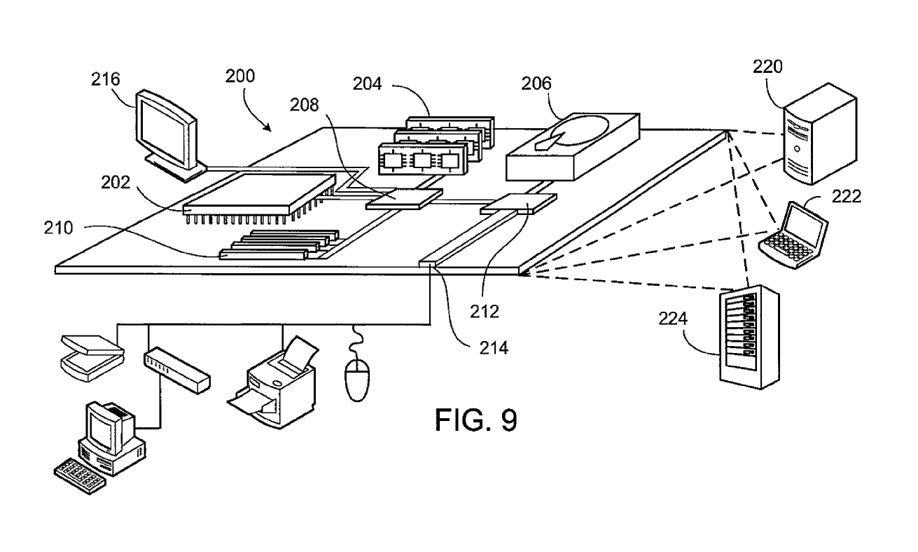

FIG. 9 is a schematic representation of a general computing system 200 that can be used to implement the servers 112 and 118, the ad network 116, the client device 108, or their components. Computing device 200 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described or claimed in this document.

Referring to FIG. 9, the computing device 200 includes a processor 202, memory 204, a storage device 206, a high-speed interface 208 connecting to memory 204 and high-speed expansion ports 210, and a low speed interface 212 connecting to low speed bus 214 and storage device 206. Each of the components 202, 204, 206, 208, 210, and 212, are interconnected using various busses, and may be mounted on a common motherboard or in other manners as appropriate. The processor 202 can process instructions for execution within the computing device 200, including instructions stored in the memory 204 or on the storage device 206 to display graphical information for a GUI on an external input/output device, such as display 216 coupled to high speed interface 208. In other implementations, multiple processors and/or multiple buses may be used, as appropriate, along with multiple memories and types of memory. Also, multiple computing devices 200 may be connected, with each device providing portions of the necessary operations (e.g., as a server bank, a group of blade servers, or a multi-processor system).

The memory 204 stores information within the computing device 200. In one implementation, the memory 204 is a volatile memory unit or units. In another implementation, the memory 204 is a non-volatile memory unit or units. The memory 204 may also be another form of computer-readable medium, such as a magnetic or optical disk.

The storage device 206 is capable of providing mass storage for the computing device 200. In one implementation, the storage device 206 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 204, the storage device 206, memory on processor 202, or a propagated signal.

The high speed controller 208 manages bandwidth-intensive operations for the computing device 200, while the low speed controller 212 manages lower bandwidth-intensive operations. Such allocation of functions is exemplary only. In one implementation, the high-speed controller 208 is coupled to memory 204, display 216 (e.g., through a graphics processor or accelerator), and to high-speed expansion ports 210, which may accept various expansion cards (not shown). In the implementation, low-speed controller 212 is coupled to storage device 206 and low-speed expansion port 214. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 200 may be implemented in a number of different forms, as shown in the figure. For example, it may be implemented as a standard server 220, or multiple times in a group of such servers. It may also be implemented as part of a rack server system 224. In addition, it may be implemented in a personal computer such as a laptop computer 222. Each of such devices (e.g., standard server, rack server system, personal computer, laptop computer) may contain one or more of computing device 200, and an entire system may be made up of multiple computing devices 200 communicating with each other.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse, trackball, touch-sensitive screen, or iDrive-like component) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations and examples have been described. Nevertheless, it will be understood that various modifications may be made without departing from the spirit and scope of the invention. For example, various forms of the flows shown above may be used, with steps re-ordered, added, or removed. Also, although several applications and methods have been described, it should be recognized that numerous other applications are contemplated. For example, while this specification contains many specific implementation details, these should not be construed as limitations on the scope of any invention or of what may be claimed, but rather as descriptions of features that may be specific to particular implementations of particular inventions. Certain features that are described in this specification in the context of separate examples can also be implemented in combination in a single example. Conversely, various features that are described in the context of a single example can also be implemented in multiple examples separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

In addition, the logic flows depicted in the figures do not require the particular order shown, or sequential order, to achieve desirable results. Other steps may be provided, or steps may be eliminated, from the described flows, and other components may be added to, or removed from, the described systems.

Accordingly, other implementations are within the scope of the following claims.

What is claimed is:

1. A computer-implemented method comprising:
at a server computer, receiving a request from a client device; and
at the server computer, delivering a web page in response to the request to the client device, the web page having a predetermined width when shown in a browser window having a width greater than the predetermined width, the web page comprising instructions to enable a web browser to display an ad module in a blank area between a border of the web page and a border of the browser window when the width of the browser window is larger than the predetermined width.

2. The method of claim 1 in which delivering the web page comprises delivering instructions for the web page to enable the web browser to determine a width of the blank area and display the ad module at a position determined according to the width of the blank area.

3. The method of claim 1 in which delivering the web page comprises delivering instructions for detecting resizing of the browser window and removing the ad module previously displayed in the blank area when the blank area has a width that is smaller than the width of the ad module.

4. The method of claim 1 in which delivering the web page comprises delivering instructions for the web page to enable the web browser to display a first ad module in a first blank area between a left border of the web page and a left border of the browser window, and a second ad module in a second blank area between a right border of the web page and a right border of the browser window.

5. The method of claim 1 in which delivering the web page comprises delivering instructions including a function call for identifying ad modules that can be shown in a blank area.

6. The method of claim 5 in which delivering the web page comprises delivering instructions including a function call for searching ad modules that are associated with a particular class name.

7. The method of claim 1, further comprising charging advertisers a first price for advertisements that are shown in the blank area and charging the advertisers a second price for advertisements that are shown within the web page, the second price being different from the first price.

8. The method of claim 1 in which delivering the web page comprises delivering instructions to enable the web browser to keep the ad module visible in the blank area independent of scrolling of the content area in the browser window.

9. The method of claim 1 in which delivering the web page comprises delivering instructions for an ad module that displays at least one of advertisements that match the content of the web page or advertisements that match search results associated with the web page.

10. A computer-implemented method comprising:
at a server computer, receiving a request from a client device; and
at the server computer, delivering content and instructions for formatting a layout of the content in response to the request to the client device, the content being formatted to be shown in a content area that has a predetermined width when shown in a window having a width greater than the predetermined width, the instructions enabling the client device to display an advertisement in a blank area between a border of the content area and a border of the window when the width of the window is larger than the predetermined width.

11. The method of claim 10 in which receiving the request comprises receiving a request to use an application program, and delivering the content and instructions comprises delivering an interface for using the application program and instructions for formatting the interface, the interface being formatted to have the predetermined width when shown in a window having a width greater than the predetermined width.

12. The method of claim 11 in which delivering the interface comprises delivering an interface for using a web-based application that is hosted on the server computer.

13. The method of claim 10 in which delivering the content comprises delivering content that includes items that are provided by a publisher of the content and advertisements that are sponsored by an entity different from the publisher, in which the advertisements shown in the blank area are in addition to the advertisements shown in the content area.

14. The method of claim 13 in which delivering the instructions comprises delivering instructions that enable the client computer to remove the advertisements in the blank area and maintain the advertisements in the content area when the window is resized to have a width that is less than the predetermined width.

15. The method of claim 10 in which delivering the content and instructions comprises delivering an advertisement module that retrieves advertisements from an ad network and allows the advertisements to be shown in the blank area.

16. The method of claim 15 in which delivering the content and instructions comprises delivering an advertisement module that retrieves advertisements from an ad network that brokers the purchase and sale of advertisements, and allows the advertisements to be shown in the blank area.

17. A computer-implemented method comprising:
at a server computer, receiving a request from a client device;
at the server computer, delivering a web page in response to the request to the client device, the web page to be shown in a browser window associated with a web browser, the web page having a content area to display content, the content area being formatted to have a predetermined width;
receiving information about a width of the browser window; and
updating the web page to display an advertisement in a blank area between a border of the content area and a border of the browser window if a width of the browser window is larger than the predetermined width.

18. The method of claim 17, further comprising calculating a width of the blank area, and formatting the advertisement for display in the blank area.

19. The method of claim 17 in which delivering the web page comprises delivering content provided by a publisher of the web page and advertisements that are sponsored by an entity different from the publisher, in which the advertisements shown in the blank area are in addition to the advertisements shown in the content area.

20. The method of claim 19, further comprising updating the web page to remove the advertisements in the blank area and maintain the advertisements in the content area when the browser window is resized to have a width that is less than the predetermined width.

21. A computer-implemented method comprising:
providing an application programming interface (API) that includes a function call for searching advertisement modules for showing advertisements in a blank area between a border of a web page and a border of a browser window,
receiving an instruction to invoke the function call, and
enabling execution of the function call to identify advertisement modules for showing advertisements in the blank area.

22. The method of claim 21 in which providing the API comprises providing a function call that calls a JavaScript program for searching the advertisement modules.

23. A computer implemented method comprising:
providing a user interface to allow an advertiser to manage on-line ads; and
providing an option for the advertiser to determine whether an on-line advertisement can be shown in a blank area outside of a web page, the content area having a predetermined width when a width of a browser window showing the web page is larger than the predetermined width.

24. The method of claim 23, further comprising providing pricing information to the advertiser to show a difference in pricing for showing the ad within the web page and showing the ad in the blank area.

25. The method of claim 23, further comprising providing an option for the advertiser to determine whether the advertisement shown in the blank area is to scroll along with the content area or remain visible on the browser window independent of scrolling of the web page in the browser window.

26. An apparatus comprising:
a storage device to store a web page comprising content and a set of instructions, the set of instructions comprising instructions for formatting the content to be displayed within the web page, the web page having a predetermined width when shown in a browser window having a width greater than the predetermined width, the set of instructions including instructions for enabling a web browser to place an ad module in a blank area between a border of the web page and a border of the browser window when the width of the browser window is larger than the predetermined width; and
a server computer to deliver the web page to a client device in response to a request from the client device.

27. The apparatus of claim 26 in which the set of instructions comprises program code for searching ad modules that are configured to be shown only in the blank area or to be shown in either the blank area or the web page.

28. An apparatus comprising:
a storage device to store a web page formatted to have a predetermined width when shown in a browser window having a width greater than the predetermined width, the web page including code to enable a web browser to display an ad module in a blank area between a border of the web page and a border of the browser window when the width of the browser window is larger than the predetermined width; and
means for delivering the web page to a client device to cause the web page to be shown in a browser window at the client device.
